(19) United States
(12) Patent Application Publication
(10) Pub. No.: US 2026/0265124 A1
(43) Pub. Date: Sep. 10, 2026

(54) CALCINATION SYSTEMS, CALCINATION METHODS AND METHOD AND SYSTEM FOR CALCINATION AND CAUSTICIZATION

(71) Applicant: LIMEARC PROCESS AB, Njutånger (SE)

(72) Inventor: Roland LUNDKVIST, Njutånger (SE)

(21) Appl. No.: 19/161,124

(22) PCT Filed: Feb. 29, 2024
(86) PCT No.: PCT/SE2024/050192

§ 371 Date: Aug. 29, 2025

(30) Foreign Application Priority Data
Mar. 1, 2023 (SE) 2350233-9
Mar. 1, 2023 (SE) 2350234-7
Sep. 19, 2023 (SE) 2351086-0

(51) Int. Cl. C04B 2/10; B01J 6/00; C04B 2/00; C04B 2/02

(52) U.S. Cl. CPC C04B 2/10; B01J 6/004; C04B 2/005; C04B 2/02; B01J 2219/00121; B01J 2219/00159; B01J 2219/0879; B01J 2219/0894

(57) ABSTRACT

A system and method that may be used for calcination of lime mud, where the input material includes calcium carbonate and calcination process products including calcium oxide and carbon dioxide. The calcination system includes a heated first calcination chamber configured to convert input material into a first calcination process product comprising gas and a solid compound; at least one, optionally thermally insulated, unheated second calcination chamber configured to receive the first calcination process product, and convert it into a second calcination process product including gas and a solid compound; and a separator configured to receive the second calcination process product from the thermally insulated second calcination chamber and separate away the gas from the solid compound.

### TECHNICAL FIELD

Embodiments herein relate in general to systems, apparatuses and methods for thermal treatment of solid chemical compounds, commonly called calcination.

In particular, embodiments herein relate to systems and methods for calcination of lime mud in a lime recovery cycle in the cellulose industry.

Thus, embodiments herein relate to calcination system configurations, calcination methods and control methods for an electrically heated calcination system, particularly with an electric gas plasma generator and more particularly for calcination of lime mud.

More specifically, embodiments herein relate to reactors and reactor arrangements in plasma heated calcination systems and methods for calcination of lime mud in a lime recovery cycle, for example in the cellulose industry.

Embodiments herein relate to systems, apparatuses and methods for slaking of quick lime (CaO), commonly called causticization. In particular, embodiments herein relate to systems and methods for causticization after the calcination of lime mud in a lime recovery cycle in the cellulose industry.

### BACKGROUND

In the general pursuit of adapting manufacturing and process industry to be more environmentally friendly and to decrease impact on climate change, there is a need for increasing capacity and efficiency in calcination process solutions, for example for recovery of lime in paper manufacturing, cement industry or metal industry.

In conventional industrial processes, calcination is carried out in furnaces or kilns usually heated by combustion or burning of fossil fuels or biofuels to achieve thermal decomposition of input material. This conventional kind of calcination is often environmentally unfriendly and has undesired impacts on climate change. Other drawbacks are for example that the equipment is bulky, the process time is long, the process is difficult to control, and investment costs for installation is high.

It has been proposed in patent publications WO 02/096820 and WO 02/096821 to employ calcination by means of electrically generated gas plasma in a plasma reactot. Compared to calcination with traditional furnaces or kilns, calcination in a calcination reactor heated by electrically generated gas plasma offers many advantages. In a plasma heated calcination system, input material is exposed to heat radiation from a plasma flame incurring a temperature in parts of the calcination reactor in the range of 3000-4000 degrees Celsius. The higher temperatures that the input material, such as lime mud, is exposed to, the faster the calcination and throughput of material in the calcination process. Capacity can be increased by full scale deployment, or in existing calcination facilities by deployment, of supplementary smaller modules of electrical gas plasma calcinatory systems. Separation of carbon dioxide (CO₂) can be conducted with a high degree of purity at low cost and heat can be recovered to a high degree. Further advantages include high energy efficiency, low degree of emission, rapid process control and possibilities to make the whole lime recovery cycle more efficient.

In conventional industrial processes, causticization is carried out simultaneously with the slaking of the quick lime that is typically output from a calcination process. Green liquor is then used for both slaking and causticization. The quick lime then typically has a very high temperature when it is mixed with the green liquor, which means that the green liquor typically needs to be cooled in beforehand in order to avoid boiling. The publication WO 02/096820 describes the slaking of quick lime with water vapor.

### Object

While throughput of material and efficiency is highly increased in a plasma heated calcination system compared to a conventional furnace or kiln based calcination system, it is desirable to increase still further the yield, and the utilization of the generated heat.

It is a general object of the present invention to provide improved calcination system configurations, calcination methods and control methods for heated calcination.

More particular objects concern improved heat management in the calcination process as well as improved material and media flow in the calcination process.

An additional object is to provide improved system configurations for causticization systems as well as calcination and causticization systems, and methods for causticization as well as for calcination and causticization.

### SUMMARY

The above indicated and other objects are achieved by embodiments of calcination systems and calcination methods described herein.

In embodiments, a calcination system comprises:
a heated first calcination chamber, configured to convert input material, e.g. lime mud, into a first calcination process product comprising gas, e.g. carbon dioxide, and a solid compound;
at least one, optionally thermally insulated, unheated second calcination chamber, configured to receive the first calcination process product, and convert it into a second calcination process product comprising gas, e.g. carbon dioxide, and a solid compound, e.g. calcium oxide; and
a separator, configured to receive the second calcination process product from the, optionally thermally insulated, second calcination chamber, and separate away the gas from the solid compound.

In further embodiments, a calcination system comprises:
an electrically heated first calcination chamber, configured to convert lime mud into first calcination process products comprising a solid compound and a gas in the form of carbon dioxide;
a first separator, configured to receive the first calcination process products from the electrically heated first calcination chamber, and separate the solid compound from the carbon dioxide;
a thermally insulated second calcination chamber, configured to receive the solid compound, and convert it into second calcination process products comprising calcium oxide and carbon dioxide; and
a second separator, configured to receive the second calcination process products from the thermally insulated second calcination chamber, and separate the calcium oxide from the carbon dioxide.

In embodiments, a calcination method comprises:
injecting input material, e.g. lime mud, into a heated first calcination chamber;
converting, in the heated first calcination chamber, the input material into a first calcination process product comprising gas, e.g. carbon dioxide, and a solid compound;
transferring the first calcination process product to at least one, optionally thermally insulated, unheated second calcination chamber;
converting, in the second calcination chamber, the first calcination process product into a second calcination process product comprising gas, such as e.g. carbon dioxide, and a solid compound, e.g. calcium oxide;
transferring the second calcination process product to a separator; and
separating, in the separator, away the gas from the solid compound.

In further embodiments, a calcination method comprises:
injecting lime mud into an electrically heated first calcination chamber;
converting, in the electrically heated first calcination chamber, lime mud into first calcination process products comprising a solid compound and a gas in the form of carbon dioxide;
transferring the first calcination process products to a first separator;
separating, in the first separator, the solid compound from the gas in the form of carbon dioxide;
transferring the solid compound to an, optionally thermally insulated second calcination chamber;
converting, in the second calcination chamber, the solid compound into second calcination process products comprising calcium oxide and gas in the form of carbon dioxide;
transferring the second calcination process products to a second separator; and
separating, in the second separator, the calcium oxide from the gas in the form of carbon dioxide.

In embodiments, the first and second calcination chambers are two chambers within a calcination reactor, which chambers are partially partitioned from each other, for example by a waist structure, and the heating of the first chamber is arranged not to heat the second chamber.

In embodiments, the calcination reactor comprises two sequential or cascaded, optionally thermally insulated, second calcination chambers, arranged so that a swirling flow is maintained in the sequential or cascaded second calcination chambers.

In embodiments, at least one, optionally thermally insulated, unheated second calcination chamber is an, optionally thermally insulated, pipe structure, through which the first calcination process product is transported to the separator.

In embodiments, the calcination system comprises a pre-separator, configured to receive the first calcination process product from the heated first calcination chamber, and separate away the gas from the solid compound before the solid compound enters the, optionally thermally insulated, second calcination chamber.

In embodiments, the first calcination chamber is electrically heated.

In embodiments, the first calcination chamber is heated using an electric gas plasma generator.

In embodiments, the volume of the first calcination chamber is substantially smaller than the volume of the second calcination chamber, e.g. in the range of 10-30% of the volume of the second calcination chamber.

In embodiments, the calcination system comprises an input for receiving input material, e.g. in the form of lime mud; input material heater, e.g. a media separated heat exchanger, coupled to the input and configured to preheat the input material; and an injection arrangement, configured to receive the input material from the input material heater and inject it into the heated first calcination chamber.

In embodiments, the calcination system comprises a filter arrangement, configured to receive gas from at least one of the separators and filter the gas to a higher degree of purity.

In embodiments, the calcination system comprises a control unit (26), communicatively coupled to sensors and control actuators, and configured to receive sensor signals, generate control signals and communicate control signals through a control port connected to one or more signal lines coupled to the sensors and control actuators.

Further embodiments are disclosed in the detailed description.

### BRIEF DESCRIPTION OF DRAWINGS

Embodiments described herein will be further explained with reference to the accompanying drawings, wherein:

FIG. 1A-C show schematic overviews of embodiments of a calcination system in accordance with exemplifying embodiments.

FIG. 2 schematically illustrates a calcination system in accordance with exemplifying embodiments.

FIG. 3 schematically illustrates an embodiment of input material heater in the form of a media separated heat exchanger in accordance with exemplifying embodiments.

FIG. 4A-B schematically illustrate exemplifying embodiments of a calcination reactor in accordance with exemplifying embodiments.

FIG. 5A-B schematically illustrate embodiments of calcination methods in accordance with exemplifying embodiments.

FIG. 6 shows a schematic overview of a causticization system in accordance with exemplifying embodiments.

FIG. 7 shows a schematic overview of a calcination and causticization system in accordance with exemplifying embodiments.

FIG. 8 schematically illustrates a calcination and causticization system in accordance with exemplifying embodiments.

FIG. 9A schematically illustrates a causticization method in accordance with exemplifying embodiments.

FIG. 9B schematically illustrates a calcination and causticization method in accordance with exemplifying embodiments.

### DETAILED DESCRIPTION

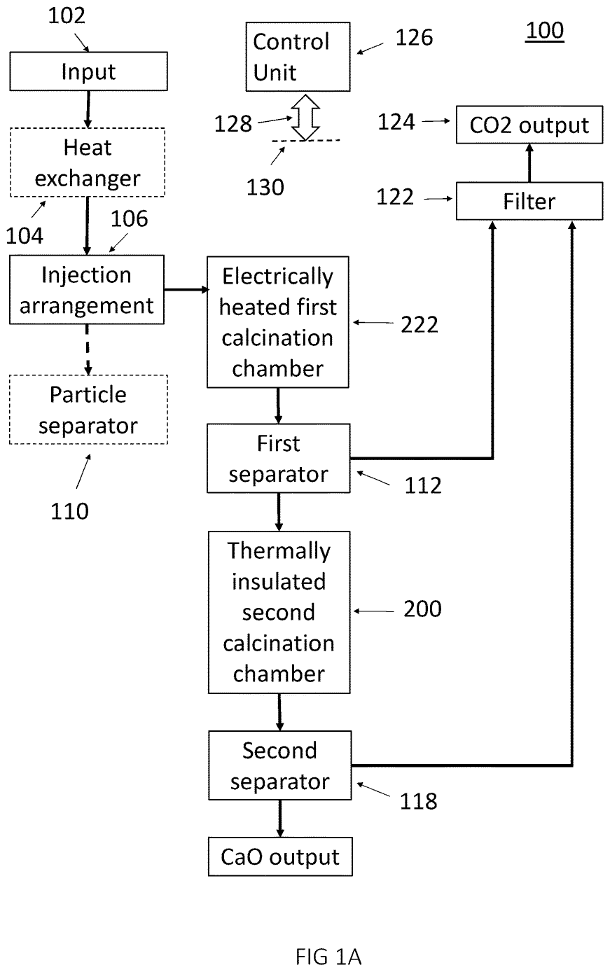

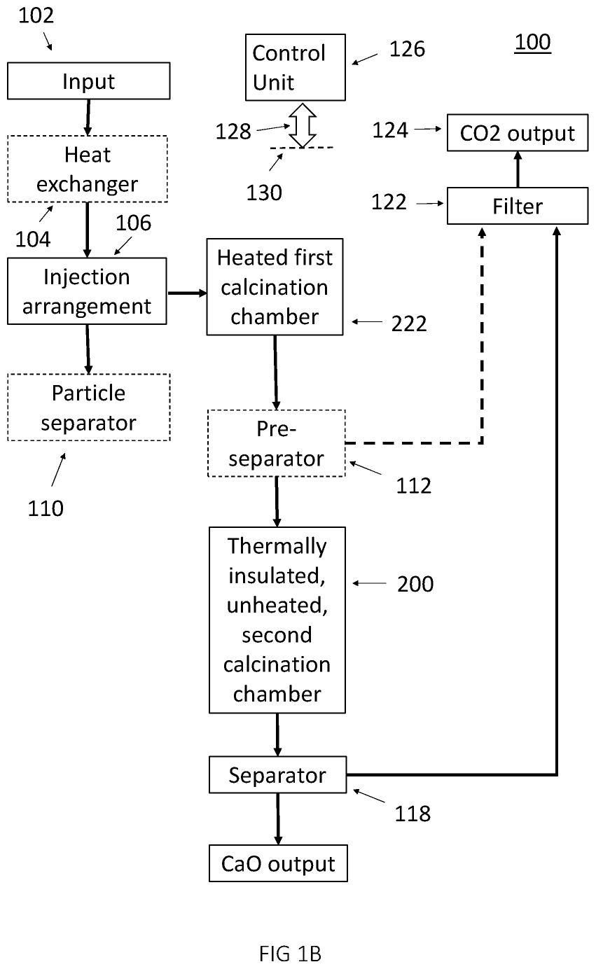

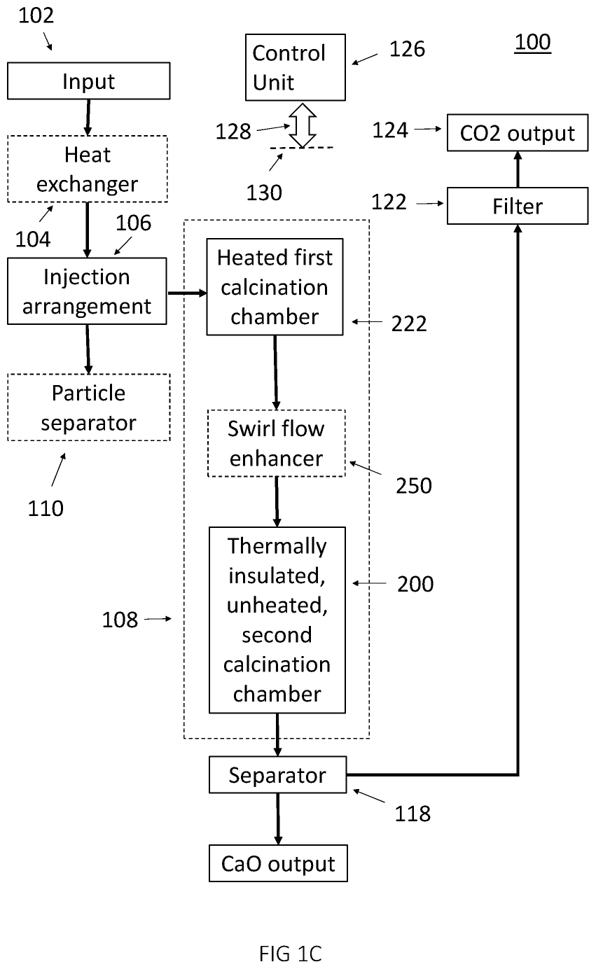

FIG. 1A-C show schematic overviews of exemplifying embodiments of a calcination system configured for carrying out embodiments of calcination methods, here exemplified by an adaptation to calcination of lime mud, for example applicable in a lime recovery cycle in the cellulose industry. However, embodiments are generally useable and/or configurable for calcination or other thermal treatment of other input materials.

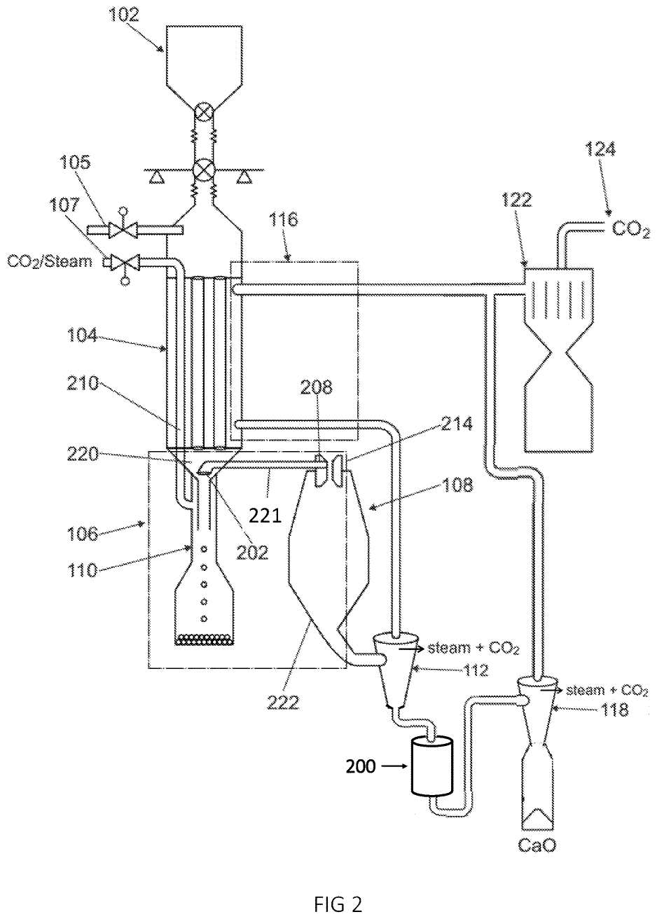

In FIG. 1A-C, system components comprised or optionally comprised in embodiments are schematically shown with arrows indicating flow channels for communicating or transporting material such as solid compound and/or gas and/or heat between the components. Details drawn with intermittent lines indicate optional features in addition to the configuration of main embodiments in fully drawn lines. FIG. 1A-C and FIG. 2 also serve as schematic flow charts for embodiments of calcination methods.

FIG. 2 schematically illustrates an exemplifying embodiment of a calcination system configured for carrying out embodiments of calcination methods, here exemplified by an adaptation to calcination of lime mud, for example applicable in a lime recovery cycle in the cellulose industry.

### Calcination

Thermal treatment of a solid chemical compound is commonly called calcination. In such a process, the compound is heated to a high temperature, below the melting point of the solid chemical compound, generally under restricted supply of ambient oxygen. The general purpose may be to achieve thermal decomposition and/or to remove impurities or volatile substances.

### Calcination of Lime

Calcination of lime, in accordance with embodiments disclosed herein, is for example applicable in lime recovery cycles in process industries such as the cellulose industry, the cement industry or the metal industry. In such lime recovery cycles, lime comprising crystal forms of calcium carbonate (CaCO3) is thermally decomposed to calcium oxide (CaO), also called quick lime, and carbon dioxide (CO2). The calcination reaction is CaCO3(s)→CaO(s)+CO2(g), where(s) denotes solid compound and (g) denotes gas form compound.

For example, in the cellulose industry, lime mud is a by-product obtained in pulp mills as part of the process that turns wood into pulp for paper. In a pulp mill, wood chips are cooked with sodium hydroxide to extract the wood fiber used to make paper from the lignin that binds the wood together. During this process, sodium hydroxide is converted to sodium carbonate. Calcium oxide, also known as quick lime, is then added to convert the sodium carbonate back to sodium hydroxide, in order to use it again. In the process, calcium carbonate in the form of lime mud is obtained. Lime mud is mainly calcium carbonate mixed with water, forming a sludge. The lime mud is calcinated in order to retrieve calcium oxide in a lime recovery cycle. Before calcination, the lime mud is preferably dried to an extent suitable for handling in connection with and in the calcination process. For example, the input material such as lime or lime mud may be pulverized into a powder in connection with the drying. Similar processes as mentioned above are applicable in other industries.

Calcination of calcium carbonate begins to occur at about 900 degrees Celsius, and normally calcination takes place at temperatures in the range 900-1100 degrees Celsius, whereby calcium oxide and carbon dioxide is formed. The calcination reaction is reversible, and in order to avoid reformulation of calcium carbonate in the presence of carbon dioxide, the temperature must be maintained above the calcination temperature. However, with temperatures rising to about 1100 degrees Celsius and above, the calcium oxide sinters. In the sintering process, the calcium oxide is compacting due to the phenomenon that calcium crystals collapse and form a solid mass of material. The rate of sintering increases with higher temperatures. Furthermore, water vapor (herein also called steam) may be used as a catalyst for sintering. In the calcination process, carbon dioxide is released from the calcium carbonate, and after sintering, the calcium oxide is more stable. After such a calcination process of lime input material comprising calcium carbonates being converted into quick lime, i.e. calcium oxide, the quick lime is usually slaked to produce slaked lime. The slaked lime is preferably causticized by being mixed with green liquor. In order to make the calcination process as efficient as possible, it is desirable to use high temperatures. The present disclosure proposes a system and method for calcination that is more efficient by letting the input material flow quickly through a, preferably electrically heated, first calcination chamber, and then (in embodiments after separating away gas such as carbon dioxide) letting the calcination process continue in an, optionally thermally insulated, unheated second calcination chamber. This allows the calcination process to start rapidly, thanks to the high temperature used, but removes the first calcination process products from the electrically heated first calcination chamber before the sintering process begins.

The calcination process products are transferred into an, optionally thermally insulated, second calcination chamber, which is not heated. In embodiments, the gas (e.g. carbon dioxide) is separated away from the solid compound in a pre-separator, and only the solid compound is transferred into the second calcination chamber. Since the solid compound of the first calcination process products already has a high temperature from having been heated in the electrically heated first calcination chamber, the calcination process will continue in the, optionally thermally insulated, second calcination chamber without further heating, albeit at a slower pace. The solid compound may remain in the second calcination chamber until the calcination process is finished, e.g. after about one hour, and then be transferred into a separator, where the gas (e.g. carbon dioxide) is separated away from the solid compound (e.g. calcium oxide).

As long as the solid compound has a temperature above 900 degrees Celsius, the calcination process will continue, albeit at a slower pace as the temperature falls. The, optionally thermally insulated, second calcination chamber is preferably large enough to continuously receive solid compound of the first calcination process products from the heated first calcination chamber, and keep the solid compound of the first calcination process products within the second calcination chamber until virtually all of the solid compound of the first calcination process products has calcinated into a solid compound oxide, e.g. calcium oxide.

### Input for Material to be Thermally Treated by Calcination

As shown in FIGS. 1A-C and 2, embodiments of a calcination system 100 comprise an input 102 for material to be thermally treated, for example an input in the form of a lime mud storage container. Typically, input material such as dried lime mud is accommodated in the input 102 and may be communicated via a valve to an input material heater, e.g. a media separated heat exchanger 104, or directly to a heated first calcination chamber 222. Thus, embodiments of the calcination system comprise an input 102 for receiving input material, for example in the form of lime mud. Embodiments of a calcination method comprise receiving input material in the form of lime mud.

Embodiments for lime calcination may be configured for input material in the form of lime raw material, which herein is material comprising calcium carbonate containing minerals or substances such as limestone, lime sludge, dolomite, calcium containing sludge.

### Injection Arrangement

An embodiment of the injection arrangement 106 is shown in FIG. 2. The injection arrangement 106 is configured to convey and inject the input material, for example heated lime mud, into a heated first calcination chamber 222 of a first calcination reactor 108. The injection arrangement is in certain embodiments coupled to a particle separator 110. Embodiments of the calcination system 100 comprise an injection arrangement 106 configured to receive input material from the input material heater, e.g media separated heat exchanger 104, or directly from the input 102, and to inject input material into a heated first calcination chamber 222. Embodiments of a calcination method comprise injecting input material into a heated first calcination chamber 222. It is not necessary for the system 100 to have an jnput material heater, e.g. a media separated heat exchanger 104—the input material may instead be input directly into the heated first calcination chamber 222, optionally after preheating in for example a conventional heat exchanger or other preheating arrangement.

Embodiments of the injection arrangement 106 comprise an inlet for an injection gas supply 107 configured to enable feeding of an injection gas at a controllable pressure, for example in the range of 1-5 atm (atmospheric pressure above vacuum). The purpose of the injection gas is to control the injection rate, the injection pressure, the distribution and/or the temperature of the pre-heated input material injected into the heated first calcination chamber 222. In embodiments, the inlet for injection gas supply is controllable by one or more actuators, preferably coupled to a control unit 126. In embodiments adapted to calcination of lime, the injection gas is carbon dioxide or steam. The injection gas is in embodiments recycled carbon dioxide recovered from the calcination process.

Embodiments of an injection arrangement 106 in a calcination system 100 comprise an injector inlet 202 configured to receive preheated input material, for example lime mud, for example from a media separated heat exchanger 104 or from an other preheating arrangement, into a fluid conductor configured for transferring the preheated input material to an injector 208; the injector 208 being configured to inject the preheated material into a heated first calcination chamber 222; and an injection gas 107 supply configured to supply gas for transfer and injection of input material into the heated first calcination chamber 222. In embodiments of the injection arrangement 106, the injection gas 107 is preheated in an injection gas tube 210 conducted through the media separated heat exchanger 104.

In embodiments combined with a particle separator, the injection arrangement 106 is configured such that the inlet 202 is positioned in a cavity configured to communicate preheated input material, for example from the media separated heat exchanger 104 or from an other preheating arrangement, to a particle separator 110 and is configured to receive a rising flow of preheated input material in a stream of injection gas 107. The injection gas 107 is in such embodiments supplied in a flow such that smaller particles are lifted by the injection gas stream. This kind of configuration is suitable in embodiments where the injector 208 is configured to inject the preheated input material into a forma 214 (also called a tuyer) of an electric plasma generator of a calcination reactor 108.

In other embodiments of the injection arrangement 106, the injector 208 is configured to inject the preheated input material into the first calcination chamber 222 of the calcination reactor 108 in an input material stream tangential in relation to a gas plasma stream generated by an electric plasma generator of the calcination reactor 108.

In embodiments of the injection arrangement 106 the injector inlet 202 and an outlet 218 for the injection gas supply is positioned at an outlet 220 of the media separated heat exchanger 104.

### Particle Separator

The particle separator 110, also shown for example in FIG. 2, is, in embodiments where it is comprised, configured to separate larger and heavier particles or lumps of preheated material, such as lime mud, from smaller and lighter particles of material. The particle separator 110 is in embodiments devised such that heavier particles or lumps of material by gravity fall into a lump collection container and such that smaller particles are lifted by a stream of pre-heated gas and input into the injector arrangement 106.

Embodiments of the particle separator 110 are provided with a controllable supply of heated gas. In embodiments the supply of heated gas is controllable by one or more actuators, preferably coupled to control unit 124. In embodiments, the gas pressure in the particle separator 110 is controlled by controlling the driving gas supply 105 on the cold side of the media separated heat exchanger 104.

Embodiments of the calcination system 100 comprise a particle separator 110 coupled to the injection arrangement 106 and configured to separate larger particles or lumps from smaller particles of solid compound in input material, and to convey the smaller particles in a gas flow to the injection arrangement 106 for injection into the electrically heated first calcination chamber 222. Embodiments of the calcination method comprise separating, in a particle separator 110 coupled to the injection arrangement 106, such that larger particles and lumps are separated from smaller particles of solid compound in input material, and conveying the smaller particles in a gas flow to the injection arrangement 106 for injection into the heated first calcination chamber 222.

The particle separator may be configured or controlled such that particles of pre-heated input material with a size in the range of 1 to 1000 micrometers are input to the calcination reactor 108 via the injection arrangement 106. With powder form the contact surface of the input material will become very large, whereby the contact time with heat in the calcination reactor can be minimized.

### Heated Calcination Reactor

The heated first calcination chamber 222 is thus configured to receive a flow of pre-heated material, such as lime mud, from the injection arrangement 106 and expose the material to heat, preferably generated by electricity, for example electrically generated gas plasma. Embodiments of the calcination system comprises a heated first calcination reactor 108 being configured to convert input material received by means of the injection arrangement 106 into first calcination process products comprising a solid compound, for example an oxide, and a gas, for example carbon dioxide. Embodiments of a calcination method comprise converting, in the heated first calcination chamber 222, input material into first calcination process products comprising a solid compound, for example an oxide, and a gas, for example carbon dioxide.

In embodiments, the first calcination chamber 222 is heated by an electric gas plasma generator 230 configured to inject hot gas plasma, such as carbon dioxide plasma, into the first calcination chamber 222, and possibly maintain production of gas plasma in the first calcination chamber 222 from gas, such as carbon dioxide, formed in the calcination process. In embodiments applied for heat treatment of lime mud, the lime mud that is exposed to the heat of the gas plasma is converted to first calcination process products comprising calcium oxide, also called quick lime, and carbon dioxide. The first calcination reactor 108 is further configured to exit the heat-treated material and if applicable calcination process products to a first separator 112.

An electric gas plasma generator 230, comprised in embodiments of the first calcination chamber 222, is devised to supply energy via an electric arc formed between electrodes. Gas is ionized and an energetic gas plasma is formed. Such gas plasma normally has a temperature in the range of 3000-4000 degrees Celsius or more at the discharge of the gas plasma generator. In a plasma heated calcination system, input material is therefore exposed to heat radiation from a plasma flame incurring a temperature in parts of the calcination reactor in the range of 3000-4000 degrees Celsius. The higher temperatures that the input material, such as lime mud, is exposed to, the faster the calcination and throughput of material in the calcination process. The gas plasma generator 230 may comprise a nozzle called forma (also called tuyer) configured to inject gas plasma into the first calcination chamber 222. Pressurized gas may be supplied to the forma to overcome a pressure drop occurring over the gas plasma generator. The pressurized gas may be used to control the temperature of the gas plasma.

Preheated input material is in the first calcination chamber 222 mixed with or exposed to hot gas from the plasma generator. The first calcination chamber 222 is in embodiments configured to balance the exposure of the pre-heated input material to heat at too high temperature. For example, for input material comprising lime with calcium carbonate exposure to calcination temperatures exceeding 1200 degrees Celsius may entail risk for inactivating the lime, also called dead burning of the lime. Configuring the first calcination chamber 222 such that the input material when injected into the first calcination chamber 222 is in powder form, thus having a large surface, and such that the powder formed input material is exposed to heat for a limited period of time, enables that inactivation of the input lime is avoided.

Generally, the input material is calcinated during fragments of seconds to a few seconds. Calcination is preferably carried out at atmospheric pressure, or at a small over-pressure or under-pressure.

In other embodiments, the first calcination chamber 222 may be heated using electric heating such as resistive technology, microwave or radio wave technology, or any other form of heating. Pre-separator

The pre-separator 112 is, in embodiments where it is comprised, configured to separate the first calcination process products generated by the heat treatment of the material in the heated first calcination chamber 222, so that gas, e.g. carbon dioxide, is separated away from solid calcination process products. The temperature of the calcination process products received from the heated first calcination chamber 222 typically exceeds 900 degrees Celsius.

In the pre-separator 112, larger and/or heavier particles in the material flow input from the heated first calcination chamber 222 are separated from smaller and/or lighter particles and gas. The larger and/or heavier particles are collected in a collection hopper, and residual calcination process products in the form of gas, usually together with a certain amount of smaller and/or lighter particles, are conducted out from the pre-separator 112. In embodiments, the pre-separator 112 is a cyclone, an electric filter, or a sedimentation device or sedimentation arrangement.

Embodiments of the calcination system 100 comprise one or more pre-separators 112 configured to separate the gas away from the solid compound. Embodiments of a calcination method comprises separating, in one or more pre-separators 112, away the gas from the solid compound from gas.

Embodiments of the calcination system 100 comprises: a pre-separator 112 configured to receive first calcination process products from the heated first calcination chamber 222 and to separate away gas from the solid compound. Embodiments of the calcination method, comprise separating, in a pre-separator 112, calcination process products received from the heated first calcination chamber 222 such that the gas is separated away from the solid compound.

### Unheated Second Calcination Chamber

The, optionally thermally insulated, second calcination chamber 200 is an unheated calcination chamber 200 configured to receive a flow of first calcination process product from the heated first calcination chamber 222 (or solid compound from the pre-separator 112, if used). The second calcination chamber 200 may be a separate container, as illustrated in FIG. 1A-B, and/or one or more separate, unheated compartments within a calcination reactor 108, as illustrated in FIG. 1C and FIG. 2. The second calcination chamber 200 may alternatively be an, optionally thermally insulated, pipe structure, through which the first calcination process product is transported to the separator 118. A length of such an optionally thermally insulated, pipe structure may for a certain size of reactor 108 be e.g. around ten meters with a diameter of e.g. one meter, in order to allow for a reasonable reaction time during the flow of the first calcination process product through the pipe structure. The second calcination chamber 200 may also be any combination of the above.

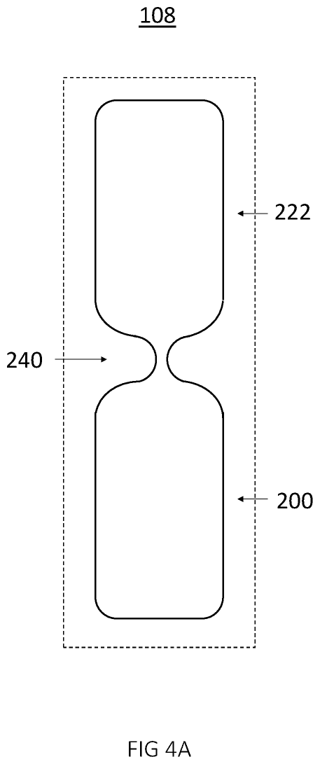

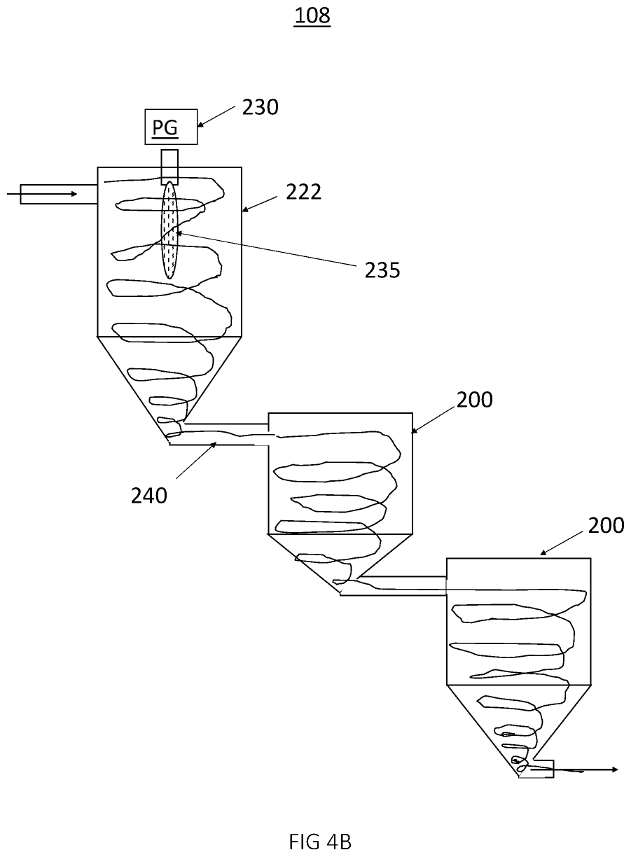

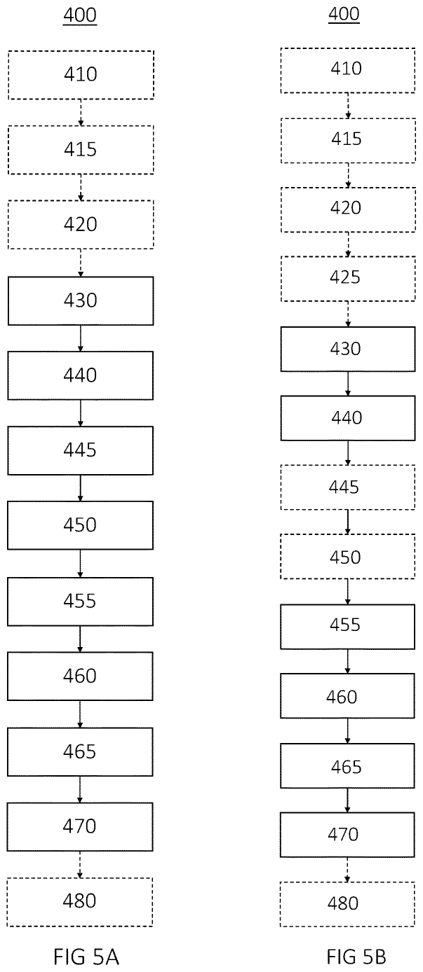

FIG. 4A-B schematically illustrate embodiments of a calcination reactor arrangement 108 comprising a heated first calcination chamber 222 and one or more, optionally thermally insulated, unheated second calcination chambers 200. An embodiment of a calcination reactor 108 comprising a first calcination chamber 222 and an, optionally thermally insulated second calcination chamber 200, partially partitioned from each other, for example by a waist structure 240, is schematically illustrated in FIG. 4A. This may be combined with an, optionally thermally insulated, second calcination chamber 200 in the form of a separate container, as illustrated in FIG. 2.

An embodiment of a calcination reactor 108 in a plasma heated calcination system is schematically illustrated in FIG. 4B. Input material is injected into the first calcination chamber 222, for example tangentially in relation to a rotational symmetry axis of the first calcination chamber 222, so that a swirling flow is created in the first calcination chamber 222. The first calcination chamber 222 is heated by a plasma stream 235 from a plasma generator 230, in such a way that the input material is exposed to the heat from the plasma stream 235. In embodiments, flow conducting flanges are configured to conduct gas injected at the arc of the plasma generator 230 to induce a swirling shape or flow of the plasma stream (also called plasma jet or plasma flame). The injection of the input material is preferably adapted to the swirl of the plasma stream, and the swirl and/or rotation of the input material flow is thereby enhanced.

The first calcination process product is then transferred into an, optionally thermally insulated, second calcination chamber 200, via an outlet 240 from the heated first calcination chamber 222, preferably in such a way that a swirling flow is maintained also in the second calcination chamber 200. As schematically illustrated in FIG. 1C, the calcination reactor 108 may comprise a swirl flow enhancer 250, for example in the form of a cyclone, configured to receive first calcination process product from the heated first calcination chamber 222, and to reinforce and/or maintain the flow rate in a swirling flow in the second calcination chamber 200.

In the embodiment schematically illustrated in FIG. 4B, the calcination reactor 108 comprises two sequential or cascaded, optionally thermally insulated, second calcination chambers 200. In this case, it is especially desirable to use some kind of swirl flow enhancer 250 to reinforce and/or maintain the flow rate in a swirling flow in the sequential or cascaded second calcination chambers 200. This may e.g. be achieved by tangential injection of the material into the sequential or cascaded second calcination chambers 200. A number of, optionally thermally insulated, second calcination chambers 200 may also, or alternatively, be arranged in parallel.

In embodiments, the volume of the first calcination chamber 222 is substantially smaller than the volume of the second calcination chamber 200, e.g. in the range of 10-30% of the volume of the second calcination chamber 200.

Larger particles of the input material are typically held for a longer time in the heated first calcination chamber 222, allowing them a longer calcination time, whereas smaller particles, that are calcinated in a shorter time, move faster into the second calcination chamber 200. The shape of the first calcination chamber 222, the second calcination chamber 200 and/or the swirl enhancer 250 may be cylindrical and/or at least partly conical, in order to promote the whirl or the rotation of the flow of material, in order to maintain a certain time of presence of the particles of the material in the chambers.

The calcination reactor or reactors with the first and/or second calcination chambers is preferably a cyclone reactor. In a cyclone calcination reactor, particles of input material whirl in a space where calcination takes place when the material is heated. In a cyclone reactor, a whirling or rotating flow takes place in a chamber that typically has a substantially rotationally symmetric, cylindrical or conical shape. Material comprising solid particles, as well as gas, flows in a whirling or helical pattern in a space in the chamber. Normally, material is input at an upper part of the chamber, flows through the chamber and is output at a lower part of the chamber.

Embodiments of the calcination system 100 comprises an, optionally thermally insulated, second calcination chamber 200 configured to convert first calcination process products received from the heated first calcination chamber 222 (or solid compound received from the pre-separator 112, if used) into second calcination process products comprising a solid compound, e.g. calcium oxide, and gas, e.g. carbon dioxide. Embodiments of a calcination method comprise converting, in the second calcination chamber 200, first calcination process products received from the heated first calcination chamber 222 (or solid compound received from the pre-separator 112, if used) into second calcination process products comprising an oxide, e.g. calcium oxide, and gas, e.g. carbon dioxide.

In embodiments, the, optionally thermally insulated, second calcination chamber 200 is configured to maintain, without any heating, a temperature of above 900 degrees Celsius, in order for the calcination process to continue within the, optionally thermally insulated, second calcination chamber 200. Since the solid compound already has a high temperature from having been heated in the heated first calcination chamber 222, the calcination process will continue in the, optionally thermally insulated, second calcination chamber 200 without further heating. As long as the solid compound has a temperature above 900 degrees Celsius, the calcination process will continue, albeit at a slower pace as the temperature falls. The second calcination chamber 200 is preferably large enough to continuously receive first calcination process products from the heated first calcination chamber 222 (or solid compound from the pre-separator 112, if used), and keep the first calcination process product within the second calcination chamber 200 until virtually all of the first calcination process products have calcinated into an oxide, e.g. calcium oxide and gas, e.g. carbon dioxide. Alternatively, the system 100 comprises a number of parallel, optionally thermally insulated, second calcination chambers 200, where the calcination process may continue for up to e.g. one hour.

In embodiments, water vapor is injected for example in the bottom of the second calcination chamber 200 in order to drive out the gas, e.g. carbon dioxide during the calcination process in the second calcination chamber 200. The water vapor in this case drives out the carbon dioxide from the solid compound, which allows the calcination process to continue to a lower temperature, such as e.g. 850 degrees Celsius, in the second calcination chamber 200. This allows for heat recovery down to a lower temperature without risking carbonation of the calcium oxide. Water vapor may be used for similar purposes also in other parts of the calcination system.

The water vapor may also act as a catalyst for sintering. Since the calcination process product typically resides for a relatively long time in the second calcination chamber 200, it is desirable to allow as much sintering as possible to take place.

The second calcination chamber 200 may also act as a kind of separator, and separate the solid compound (e.g. calcium oxide) from the bottom of the second calcination chamber 200 into a storage container, while allowing the gas to exit from the top of the second calcination chamber 200 to a separator 118.

Since the calcination process stops when the temperature falls below around 900 degrees Celsius, a heat recovery system may be arranged after the second calcination chamber 200, to recover the heat energy from the second calcination process products. Such a heat recovery system is preferably arranged after the separation of the gas from the solid compound in the second calcination chamber 200.

### Separator

The second calcination process products are conducted to a separator 118 configured to separate the second calcination process products. For example, remaining solid compounds is separated from gas. In embodiments the second separator 118 is a cyclone. In embodiments of the calcination system configured for lime recovery from lime mud, residual calcium oxide is further separated from carbon dioxide. Solid compounds, such as calcium oxide in lime calcination embodiments, is collected in a collection hopper and the gas, such as carbon dioxide, is conducted to a filter arrangement 122.

In embodiments applied for lime recovery from a lime mud, the residual calcination process products output from the separator 118 will comprise and usually mainly consist of carbon dioxide and fine-grained residual calcium oxide (quick lime). In embodiments of such lime recovery, a separation ratio in a cyclone variant of the separator 118 would for example be in the range of 75% of the calcium oxide (quick lime) input from the second calcination chamber 200 being collected in the collection hopper and in the range of 25% of the calcium oxide (quick lime) being output from the separator 118 together with carbon dioxide.

Embodiments of the calcination system 100 comprise: a separator 118 configured to receive second calcination process products output from the, optionally thermally insulated, second calcination chamber 200, the second separator 118 being configured to further separate solid compound, for example in the form of calcium oxide, from the gas, for example in the form of carbon dioxide. Embodiments of the calcination method comprise separating, in a second separator 118, second calcination process products received from the second calcination chamber 200, such that further solid compound, for example in the form of calcium oxide, is separated from the gas, for example in the form of carbon dioxide.

### Filter Arrangement

The filter arrangement 122, in embodiments where it is comprised, is configured to filter the gas component of the calcination process products to a higher degree of purity before collecting, storing and/or using the output gas. In lime calcination embodiments, the gas component of the calcination process products is carbon dioxide. In such embodiments, the filter arrangement 122 would comprise a filter adapted to filter carbon dioxide. The filtered gas component of the calcination process products is conducted to a gas output 124. If the temperature of the gas has been decreased to a low temperature of e.g. 200 degrees Celsius, textile filters may be applied.

The filter arrangement 122 is in embodiments configured to filter out possible dust and such impurities still present in the gas output from the second separator 118. The filter arrangement is selected to fit to the temperature levels of the gas from the separator 118.

Embodiments of the calcination system comprise a filter arrangement 122 configured to receive gas, for example in the form of carbon dioxide, from one or more of the separators 112, 118 and to filter the gas to a higher degree of purity. Embodiments of the calcination method comprises filtering, in a filter arrangement 122, gas, for example in the form of carbon dioxide, received from one or more of the separators 112, 118, such that the gas is filtered to a higher degree of purity.

### Gas Output

The gas output 124 is configured to receive the gas component of the calcination process products, and is in different embodiments configured to store, temporarily or for a longer term, or conduct the gas to the calcination system itself or to other systems and/or processes. In lime calcination embodiments the gas conducted to the gas output 124 would be carbon dioxide, and the gas would in embodiments be recirculated to the calcination reactor 108.

### Control Unit

A control unit 126, comprised in embodiments, is configured to receive sensor signals, to generate control signals and to communicate control signals through a control port 128 connected to one or more signal lines 130. The one or more signal lines is schematically indicated as an intermittent line that is connected to sensors and/or control actuators (not shown) at different points and components of the calcination system in order to control various parameters.

Embodiments of the calcination system 100 comprise a control unit 126 communicatively coupled to sensors and control actuators and configured to receive sensor signals, to generate control signals and to communicate control signals through a control port 128 connected to one or more signal lines 130 coupled to the sensors and control actuators. Embodiments of the calcination method comprise in a control unit 126 communicatively coupled to sensors and control actuators, receiving sensor signals, generating control signals and communicating control signals through a control port 128 connected to one or more signal lines 130 coupled to the sensors and control actuators.

In embodiments of the calcination system 100, the control unit is configured to control one or more of: driving gas supply 105 into the media separated heat exchanger 104; injection gas supply 107 into the injection arrangement 106; heated gas in the particle separator 110; gas pressure in the first calcination chamber 222; and/or temperature in the first calcination chamber 222. Embodiments of the calcination method, further comprise controlling one or more of: driving gas supply 105 into the media separated heat exchanger 104; injection gas supply 107 into the injection arrangement 106; heated gas in the particle separator 110; gas pressure in the first calcination chamber 222; and/or temperature in the first calcination chamber 222.

### Input Material Heater-Preheater Arrangement

Embodiments of a calcination system as described herein comprises a preheater or a preheating arrangement 104 (Cf. FIGS. 1A-C, 2 and 3) for the purpose of raising the temperature of the input material before it is entered or injected into a heated reactor chamber. This is herein also called an input material heater. In a configuration of the calcination system applied for lime recovery, the input material in the form of lime mud preferably and ideally holds a temperature in the range of 900 degrees Celsius after preheating. In embodiments using any type of heat exchanger or preheaters, the input material is preheated to e.g. a temperature of 500-600 degrees Celsius, but ideally to a temperature in the range of 900 degrees Celsius. The preheater may comprise any technology suitable for transferring or incurring heat to the input material, for example a heat exchanger.

In embodiments, the preheater may be a media separated heat exchanger. The purpose of using a media separated heat exchanger 104 is to raise the temperature of the input material without recirculation of material. Embodiments of the calcination system 100 comprises a media separated heat exchanger 104 coupled to the input and configured to conduct input material in a plurality of channels, for example tubes. Embodiments of a calcination method comprises conducting the input material in a plurality of channels of a media separated heat exchanger 104.

Input material, such as lime mud, may pass through and be heated by the media separated heat exchanger 104, and is output to an injection arrangement 106 via an outlet (not shown) from the media separated heat exchanger 104. In a configuration of the calcination system applied for lime recovery, the input material in the form of lime mud preferably and ideally holds a temperature in the range of 900 degrees Celsius when it leaves the media separated heat exchanger 104.

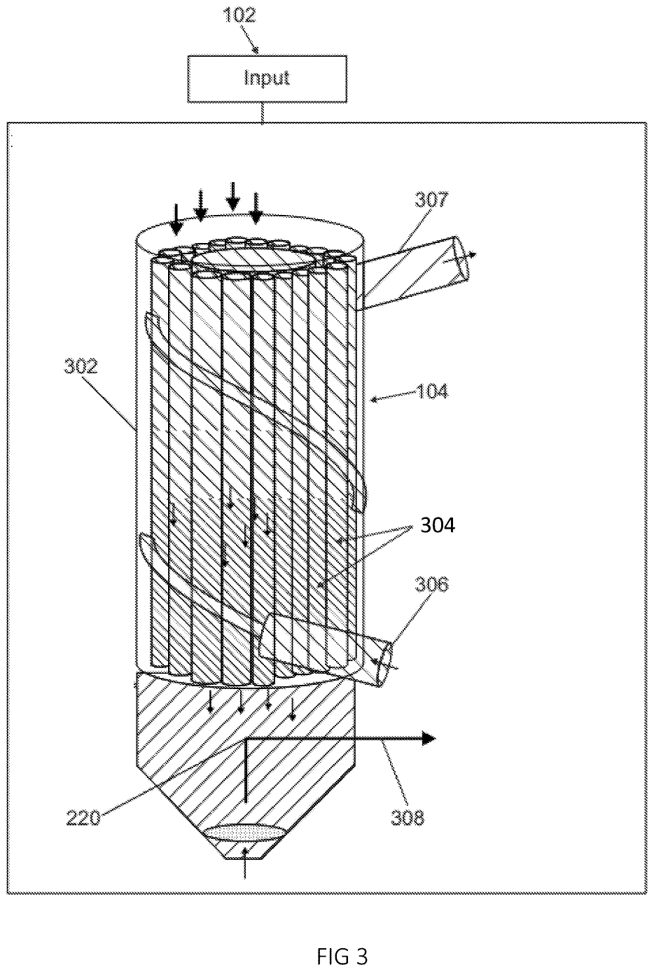

An embodiment of the media separated heat exchanger 104 is shown in FIG. 3. FIG. 3 shows a media separated heat exchanger 104 for use in a system 100 for calcination of lime mud, or in any other system for heating of fine-grained solid material, in accordance with embodiments herein. The illustrated media separated heat exchanger 104 comprises an outer shell 302 and one or more tubes 304 arranged inside the shell 302. In operation, a first medium being input material, e.g lime mud, is lead through the tubes, and hot gas, e.g. carbon dioxide, is led outside the tubes within the outer shell, or vice versa.

### General Embodiments of a Calcination System and a Calcination Method

General embodiments are schematically illustrated in FIGS. 1A-C, 2 and 4A-B.

Embodiments of a calcination system (100), comprise a heated first calcination chamber 222, configured to convert input material, e.g. lime mud, into a first calcination process product comprising gas, e.g. carbon dioxide, and a solid compound; at least one, optionally thermally insulated, unheated, second calcination chamber 200, configured to receive the first calcination process product, and convert it into a second calcination process product comprising gas, e.g. carbon dioxide, and a solid compound, e.g. calcium oxide; and a separator (118), configured to receive the second calcination process product from the second calcination chamber (200), and separate the gas away from the solid compound.

Embodiments of a calcination system 100 comprise: an electrically heated first calcination chamber 222, configured to convert lime mud into first calcination process products comprising a solid compound and a gas in the form of carbon dioxide; a first separator 112, configured to receive the first calcination process products from the electrically heated first calcination chamber 222, and separate the solid compound from the carbon dioxide; an, optionally thermally insulated, second calcination chamber 200, configured to receive the solid compound, and convert it into second calcination process products comprising calcium oxide and carbon dioxide; and a second separator 118, configured to receive the second calcination process products from the, optionally thermally insulated, second calcination chamber 200, and separate the calcium oxide from the carbon dioxide. This is schematically illustrated in FIGS. 1A-C and 2.

Embodiments of a calcination method 400 comprise: injecting 430 lime mud into an electrically heated first calcination chamber 222; converting 440, in the electrically heated first calcination chamber 222, lime mud into first calcination process products comprising a solid compound and a gas in the form of carbon dioxide; transferring 445 the first calcination process products to a first separator 112; separating 450, in the first separator 112, the solid compound from the gas in the form of carbon dioxide; transferring 455 the solid compound to an, optionally thermally insulated second calcination chamber 200; converting 460, in the, optionally insulated thermally insulated second calcination chamber 200, the solid compound into second calcination process products comprising calcium oxide and gas in the form of carbon dioxide; transferring 465 the second calcination process products to a second separator 118; and separating 470, in the second separator 118, the calcium oxide from the gas in the form of carbon dioxide. This is schematically illustrated in FIG. 4.

The foregoing disclosure is not intended to limit the present disclosure to the precise forms or particular fields of use disclosed. It is contemplated that various alternate embodiments and/or modifications to the present embodiments, whether explicitly described or implied herein, are possible in the light of the disclosure. Embodiments described in this disclosure may be applied independently or in combination with other embodiments described herein. Thus, any embodiment of systems, reactor arrangements, reactor chamber arrangements or any other arrangements disclosed herein, as well as any methods, may be applied independently or in any combination with any other embodiments described herein.

### System and Method for Calcination and Causticization

Embodiments described herein may be combined with systems and methods for causticization.

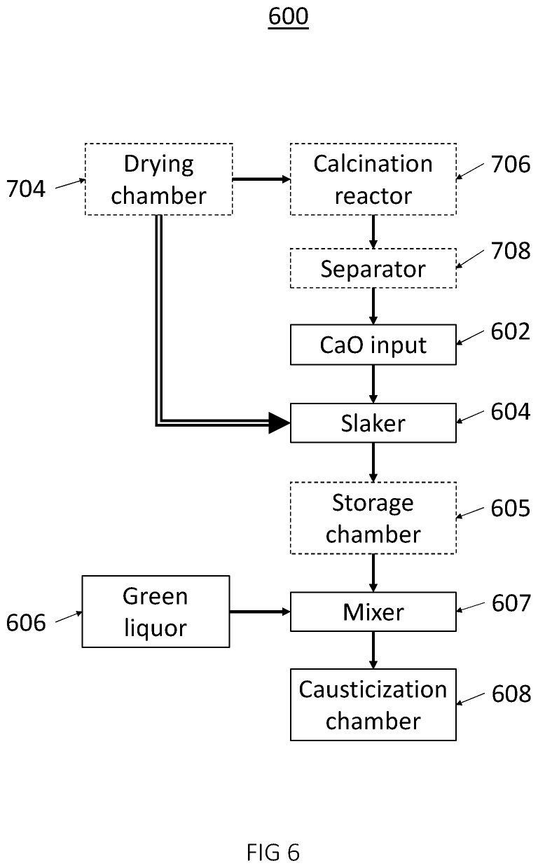

FIG. 6 shows a schematic overview of an exemplifying embodiment of a causticization system configured for carrying out embodiments of causticization methods, here exemplified by an adaptation to causticization of quick lime, for example applicable in a lime recovery cycle in the cellulose industry. However, embodiments are generally useable and/or configurable for causticization of other input materials.

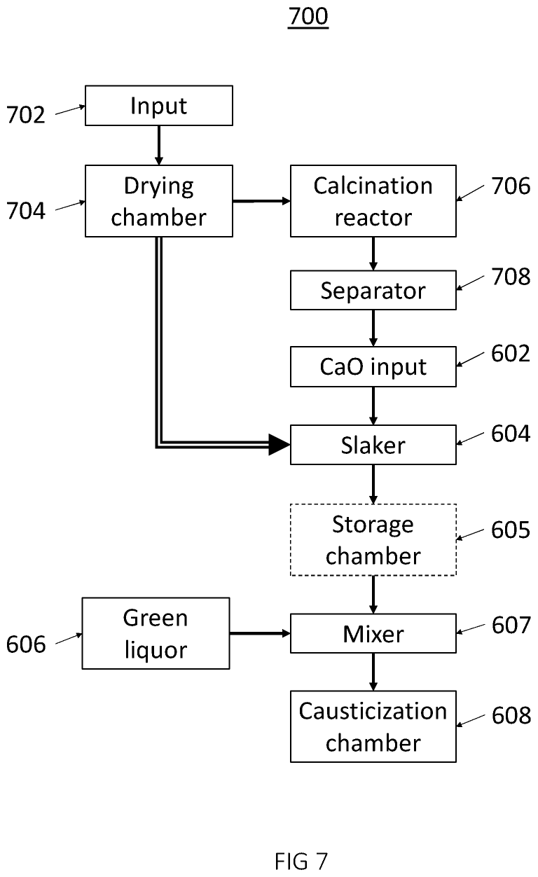

FIG. 7 shows a schematic overview of an exemplifying embodiment of a calcination and causticization system configured for carrying out embodiments of calcination and causticization methods, here exemplified by an adaptation to calcination and causticization of lime mud, for example applicable in a lime recovery cycle in the cellulose industry. However, embodiments are generally useable and/or configurable for calcination and causticization of other input materials.

In FIGS. 6 and 7, system components comprised or optionally comprised in embodiments are schematically shown with arrows indicating flow channels for communicating or transporting material such as solid compounds and/or gas and/or heat between the components. Details drawn with intermittent lines indicate optional features in addition to the configuration of main embodiments in fully drawn lines. FIGS. 1 and 2 also serve as schematic flow charts for embodiments of calcination and causticization methods.

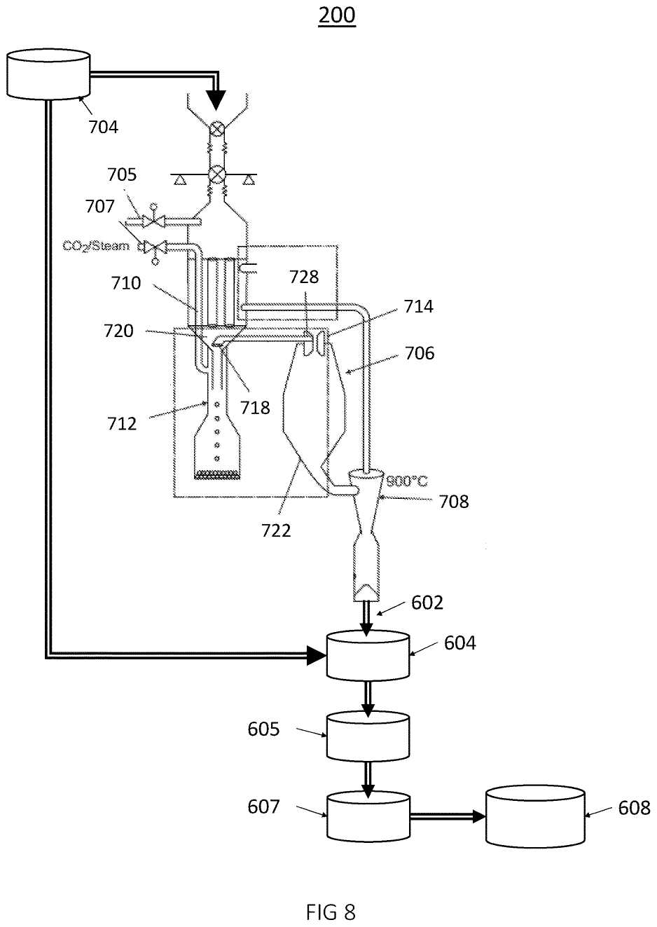

FIG. 8 schematically illustrates a calcination and causticization system configured for carrying out embodiments of calcination and causticization methods, here exemplified by an adaptation to calcination and causticization of lime mud, for example applicable in a lime recovery cycle in the cellulose industry.

After a calcination process of lime input material comprising calcium carbonates being converted into quick lime, i.e. calcium oxide, the quick lime is usually slaked to produce slaked lime. The slaked lime is preferably causticized by being mixed with green liquor.

### Causticization of Slaked Lime

In conventional industrial processes, causticization is carried out simultaneously with the slaking of the quick lime. Green liquor is then used for both slaking and causticization. The quick lime then typically has a very high temperature when it is mixed with the green liquor, which means that the green liquor typically needs to be cooled in beforehand in order to avoid boiling.

It is proposed to instead slake the quick lime using water vapor, preferably water vapor from a lime mud drying chamber arranged to dry the lime mud before the calcination process. During or after this slaking process, heat energy from the quick lime may be recovered using a heat recovery arrangement e.g. based on steam. The slaked lime may then be stored in a storage container, as long as it is has a temperature of at least 103 degrees Celsius when it is introduced into the mixer, since it will otherwise cool the green liquor.

### Input to Calcination System

A calcination system may comprise an input 702 for material to be thermally treated, for example an input in the form of a lime mud storage container. The lime mud is typically dried in a lime mud drying chamber 9704, configured to extract water vapor from the lime mud, thereby turning it into dried lime mud.

Typically, input material such as dried lime mud may be communicated via a valve to a calcination chamber 722 of a calcination reactor 706, optionally via a media separated heat exchanger where the dried lime mud may be heated. The input material may e.g. be injected into the first calcination chamber 722 of the first calcination reactor 706 in an input material stream tangential in relation to a gas plasma stream generated by an electric plasma generator of the first calcination reactor 706.

The calcination system may comprise an inlet for an injection gas supply 707707 configured to enable feeding of an injection gas at a controllable pressure, for example in the range of 1-5 atm (atmospheric pressure above vacuum). The purpose of the injection gas is to control the injection rate, the injection pressure, the distribution and/or the temperature of the dried lime mud injected into the calcination reactor 706. In embodiments adapted to calcination of lime, the injection gas is carbon dioxide or steam. The injection gas is in embodiments recycled carbon dioxide recovered from the calcination process. The injection gas may be preheated in an injection gas tube 710 conducted through the media separated heat exchanger. The injector inlet and an outlet for the injection gas supply 707 may be positioned at an outlet 720 of the media separated heat exchanger.

In embodiments combined with a particle separator 712712, the injection gas may be supplied in a flow such that smaller particles are lifted by the injection gas stream. The particle separator 712, may be configured to separate larger and heavier lumps of preheated material, such as lime mud, from smaller and lighter particles of material, through lumps of material by gravity falling into a lump collection container and smaller particles being lifted by the injection gas stream. In embodiments, the gas pressure in the particle separator is controlled by controlling a driving gas supply 705 on the cold side of the media separated heat exchanger. The particle separator may be configured or controlled such that particles of pre-heated input material with a size in the range of 1 to 1000 micrometers are input to the calcination reactor 706. With powder form the contact surface of the input material will become very large, whereby the contact time with heat in the calcination reactor can be minimized.

Embodiments for lime calcination may be configured for input material in the form of lime raw material, which herein is material comprising calcium carbonate containing minerals or substances such as limestone, lime sludge, dolomite, calcium containing sludge.

### Calcination Reactor in Calcination and Causticization System and Method

The calcination reactor 706 may be configured to receive a flow of dried lime mud, and expose it to heat generated by electricity, thereby converting the dried lime mud into calcination process products comprising a solid compound in the form of calcium oxide, also called quick lime, and a gas in the form of carbon dioxide.

In embodiments, the calcination reactor is electrically heated by an electric gas plasma generator configured to inject hot gas plasma, such as carbon dioxide plasma, into a first calcination chamber 722 of the first calcination reactor 706, and possibly maintain production of gas plasma in the calcination chamber 722 from carbon dioxide formed in the calcination process. The dried lime mud that is exposed to the heat of the gas plasma is converted to calcination process products in the form of calcium oxide and carbon dioxide. The first calcination reactor 706 is configured to exit the calcium oxide to a separator 708.

An electric gas plasma generator, comprised in embodiments of the calcination reactor 706, is devised to supply energy via an electric arc formed between electrodes. Gas is ionized and an energetic gas plasma is formed. Such gas plasma normally has a temperature in the range of 3000-900A0 degrees Celsius or more at the discharge of the gas plasma generator. The gas plasma generator comprises a nozzle called forma configured to inject gas plasma into the calcination chamber 722. Pressurized gas may be supplied to the forma to overcome a pressure drop occurring over the gas plasma generator. The pressurized gas may be used to control the temperature of the gas plasma.

Dried lime mud is in the calcination reactor mixed with or exposed to hot gas from the plasma generator. The calcination reactor 706 is in embodiments configured to balance the exposure of dried lime mud to heat at too high temperature. Exposure to calcination temperatures exceeding 1200 degrees Celsius may entail risk for inactivating the lime, also called dead burning of the lime. Configuring the calcination reactor 706 such that the input material when injected in the calcination reactor 706 is in powder form, thus having a large surface, and such that the powder formed input material is exposed to heat for a limited period of time, enables that inactivation of the input lime is avoided.

In other embodiments, the calcination chamber 722 may be electrically heated using resistive technology, microwave or radio wave technology, or other electrically driven heating.

Generally, the input material is calcinated during fragments of seconds to a few seconds. Calcination is preferably carried out at atmospheric pressure, or at a small over-pressure or under-pressure.

### Separator

The calcination process products are preferably conducted to a separator 708 configured to separate the second calcination process products by separating the calcium oxide from the carbon dioxide. The calcium oxide is typically collected in a collection hopper and the carbon dioxide, usually together with a certain amount of smaller and/or lighter particles, is typically conducted to a filter arrangement. In embodiments, the separator 708 is a cyclone, an electric filter, or a sedimentation device or sedimentation arrangement.

The separator 708 is configured to separate the process products generated by the heat treatment of the material in the calcination reactor 706. The temperature of the calcination process products received from the calcination reactor 706 typically exceeds 900 degrees Celsius.

Since the calcination process stops when the temperature falls below 900 degrees Celsius, there may be a heat recovery arrangement after the calcination reactor 706, to recover the heat energy from the calcination process products. The calcium oxide may e.g. be 200-250 degrees Celsius after such a heat recovery. Such a heat recovery arrangement is preferably arranged after the separation of the carbon dioxide from the calcium oxide.

The residual calcination process products output from the separator 708 will typically comprise and usually mainly consist of carbon dioxide and fine-grained residual calcium oxide (quick lime). In embodiments, a separation ratio in a cyclone variant of the separator 708 would for example be in the range of 75% of the calcium oxide input from the calcination reactor 706 being collected in the collection hopper and in the range of 25% of the calcium oxide being output from the separator 708 together with carbon dioxide.

### Slaker

The calcium oxide output from the calcination process is slaked with water vapor in the slaker 9604, to produce calcium oxide, also called slaked lime. During the slaking process, heat energy may be recovered using a heat recovery arrangement e.g. based on steam. The heat energy may e.g. be used in a media separated heat exchanger that may be arranged to heat the lime mud before calcination.

The water vapor may be taken from any steam supply, but preferably the water vapor extracted from the lime mud in the lime mud drying chamber 9704 is used. This water vapor needs to be cleaned in order to be usable for any other purposes, and it is thus advantageous to instead use it for slaking the calcium oxide. The water vapor typically also contains lime mud residues, which may thereby be recovered.

### Storage Container

If it is not desirable to transfer the slaked lime directly to the mixer 607 for causticization, the slaked lime may be stored in a storage container 605. In order to ensure that the temperature of the slaked lime is maintained above 103 degrees Celsius, the storage container 605 is preferably thermally insulated. The storage container 605 may have any suitable shape.

### Mixer

The slaked calcium oxide or slaked lime is transferred to a mixer 607, where it is mixed with green liquor, preferably from a green liquor storage 606. The green liquor is preferably heated to around 103 degrees Celsius before being introduced into the mixer 607. The heating may e.g. be effected in a condenser using hot water vapor extracted from the lime mud in the lime mud drying chamber 9704. The slaked lime preferably has a temperature of at least 103 degrees Celsius when it is introduced into the mixer 607. The mixer 607 may have any suitable shape.

### Causticization Chamber

When the slaked calcium oxide or slaked lime has been mixed with the green liquor, it is preferably transferred to a causticization chamber 608, where the causticization process may take place. The system may in embodiments comprise a number of such causticization chambers 608, arranged in parallel, to ensure that the causticization process is allowed enough time to finish.

### Input Material Heating—Preheating

As in embodiments of calcinations systems and methos described in previous sections herein, input material may be heated to a temperature for example in the range of 900 degrees Celsius before introducing it into the calcination reactor 706. For example, the input material may be heated by means of a heat exchanger, for example a media separated heat exchanger.

### General Embodiments of Calcination and Causticization Systems and Methods

Embodiments of a causticization system 100 comprise: a CaO input 602 for receiving input material in the form of calcium oxide from a calcination process; a slaker 9604, configured to slake the calcium oxide with water vapor; a mixer 607, configured to mix the slaked calcium oxide with green liquor; and one or more causticization chambers 608, configured to causticizate the mixture; wherein the causticization system 600 is configured to ensure that the slaked calcium oxide has a temperature of at least 103 degrees Celsius when it is introduced into the mixer 607. This is schematically illustrated in FIG. 6.

Embodiments of a calcination and causticization system 700 comprise: an input 702 for receiving input material in the form of lime mud; a lime mud drying chamber 9704, configured to extract water vapor from the lime mud, thereby turning it into dried lime mud; at least one calcination reactor 607, configured to convert the dried lime mud into calcination process products comprising a solid compound in the form of calcium oxide and a gas in the form of carbon dioxide; at least one separator 708, configured to receive the calcination process products from the at least one calcination reactor 607, and separate the calcium oxide from the carbon dioxide; a slaker 9604, configured to slake the calcium oxide with water vapor extracted from the lime mud in the lime mud drying chamber; a mixer 607, configured to mix the slaked calcium oxide with green liquor; and one or more causticization chambers 608, configured to causticizate the mixture; wherein the calcination and causticization system 700 is configured to ensure that the slaked calcium oxide has a temperature of at least 103 degrees Celsius when it is introduced into the mixer 607. This is schematically illustrated in FIGS. 2 and 3.

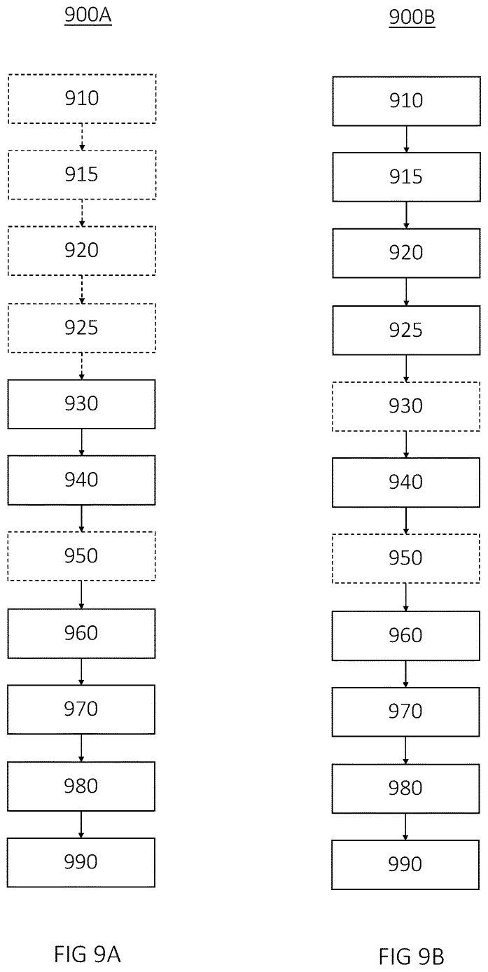

Embodiments of a causticization method comprise: receiving 930 input material in the form of calcium oxide from a calcination process; slaking 940 the calcium oxide with water vapor in a slaker 9604; transferring 960 the slaked calcium oxide, at a temperature of at least 103 degrees Celsius, to a mixer 607; mixing 970 the slaked calcium oxide with green liquor in the mixer 607; transferring 980 the mixture to one or more causticization chambers 608; and causticizating 990 the mixture in the one or more causticization chambers 608. This is schematically illustrated in FIG. 9A.

Embodiments of a causticization and calcination method comprise: receiving 910 input material in the form of lime mud; extracting 915 water vapor from the lime mud a lime mud drying chamber 9704, thereby turning the lime mud into dried lime mud; converting 920, in at least one calcination reactor 607, the dried lime mud into calcination process products comprising a solid compound in the form of calcium oxide and a gas in the form of carbon dioxide; receiving 925 the calcination process products from the at least one calcination reactor 706 in at least one separator 708, and separating the calcium oxide from the carbon dioxide; slaking 940 the calcium oxide in a slaker 9604, using water vapor extracted from the lime mud in the lime mud drying chamber 9704; transferring 960 the slaked calcium oxide, at a temperature of at least 103 degrees Celsius, to a mixer 607; mixing 970 the slaked calcium oxide with green liquor in the mixer 607; transferring 980 the mixture to one or more causticization chambers 608; and causticizating 990 the mixture in the one or more causticization chambers 608. This is schematically illustrated in FIG. 9B.

Embodiments may comprise, in combination with or independent from other embodiments described herein, a causticization system (600), comprising:
a CaO input (602) for receiving input material in the form of calcium oxide from a calcination process;
a slaker (9604), configured to slake the calcium oxide with water vapor;
a mixer (607), configured to mix the slaked calcium oxide with green liquor; and
one or more causticization chambers (608), configured to causticizate the mixture;
   wherein the causticization system (600) is configured to ensure that the slaked calcium oxide has a temperature of at least 103 degrees Celsius when it is introduced into the mixer (607).

The causticization system (600) may be configured to take the water vapor from a lime mud drying chamber (9704) arranged to dry the lime mud before the calcination process. Embodiments of the causticization system (600) may further comprise at least one slaked calcium oxide storage container (605), configured to store the slaked calcium oxide before it is introduced into the mixer.

Embodiments may comprise, in combination with or independent from other embodiments described herein, a calcination and causticization system (700), comprising:
an input (702) for receiving input material in the form of lime mud;
a lime mud drying chamber (9704), configured to extract water vapor from the lime mud, thereby turning it into dried lime mud;
at least one calcination reactor (706), configured to convert the dried lime mud into calcination process products comprising a solid compound in the form of calcium oxide and a gas in the form of carbon dioxide;
at least one separator (708), configured to receive the calcination process products from the at least one calcination reactor (706), and separate the calcium oxide from the carbon dioxide;
a slaker (9604), configured to slake the calcium oxide with water vapor extracted from the lime mud in the lime mud drying chamber (9704);
a mixer (607), configured to mix the slaked calcium oxide with green liquor; and
one or more causticization chambers (608), configured to causticizate the mixture;
   wherein the calcination and causticization system (700) is configured to ensure that the slaked calcium oxide has a temperature of at least 103 degrees Celsius when it is introduced into the mixer (607).

The calcination and causticization system (700) may further comprise at least one slaked calcium oxide storage container (605), configured to store the slaked calcium oxide before it is introduced into the mixer (607).

Embodiments may comprise, in combination with or independent from other embodiments described herein, a causticization method (900A), comprising:
receiving (930) input material in the form of calcium oxide from a calcination process;
slaking (940) the calcium oxide with water vapor in a slaker (9604);
transferring (960) the slaked calcium oxide, at a temperature of at least 103 degrees Celsius, to a mixer (607);
mixing (970) the slaked calcium oxide with green liquor in the mixer (607);
transferring (980) the mixture to one or more causticization chambers (608); and
causticizating (990) the mixture in the one or more causticization chambers (608).

The causticization method (900A) may further comprise the calcium oxide being slaked with water vapor extracted from the lime mud in a lime mud drying process taking place before the lime mud enters the calcination process. The causticization method (900A) may further comprise storing (950) the slaked calcium oxide in at least one slaked calcium oxide storage container (605), before it is introduced into the mixer (607).

Embodiments may comprise, in combination with or independent from other embodiments described herein, a calcination and causticization method (900B), comprising:
receiving (910) input material in the form of lime mud;
extracting (915) water vapor from the lime mud a lime mud drying chamber (9704), thereby turning the lime mud into dried lime mud;
converting (920), in at least one calcination reactor (706), the dried lime mud into calcination process products comprising a solid compound in the form of calcium oxide and a gas in the form of carbon dioxide;
receiving (925) the calcination process products from the at least one calcination reactor (706) in at least one separator (708), and separating the calcium oxide from the carbon dioxide;
slaking (940) the calcium oxide in a slaker (9604), using water vapor extracted from the lime mud in the lime mud drying chamber (9704);
transferring (960) the slaked calcium oxide, at a temperature of at least 103 degrees Celsius, to a mixer (607);
mixing (970) the slaked calcium oxide with green liquor in the mixer (607);
transferring (980) the mixture to one or more causticization chambers (608); and
causticizating (990) the mixture in the one or more causticization chambers (608).

The calcination and causticization method (900B) may further comprise storing (950) the slaked calcium oxide in at least one slaked calcium oxide storage container (605), before it is introduced into the mixer (607).

Embodiments described in this disclosure may be applied independently or in combination with other embodiments described herein.

1. A calcination system, comprising:
a heated first calcination chamber configured to convert input material into a first calcination process product comprising gas and a solid compound;
at least one, optionally thermally insulated, unheated second calcination chamber configured to receive the first calcination process product, and convert it into a second calcination process product comprising gas and a solid compound; and
a separator configured to receive the second calcination process product from the thermally insulated second calcination chamber and separate away the gas from the solid compound.

2. The calcination system of claim 1, wherein the first and second calcination chambers are two chambers within a calcination reactor, which chambers are partially partitioned from each other, and wherein the heating of the first chamber is arranged not to heat the second chamber.

3. The calcination system of claim 1, wherein the calcination reactor comprises two sequential or cascaded, optionally thermally insulated, second calcination chambers, arranged so that a swirling flow is maintained in the sequential or cascaded thermally insulated second calcination chambers.

4. The calcination system of claim 1, wherein at least one, optionally thermally insulated, unheated second calcination chamber is an, optionally thermally insulated, pipe structure, through which the first calcination process product is transported to the separator.

5. The calcination system of claim 1, further comprising a pre-separator configured to receive the first calcination process product from the heated first calcination chamber and separate the gas from the solid compound before the solid compound enters the, optionally thermally insulated, second calcination chamber.

6. The calcination system of claim 1, wherein the first calcination chamber is electrically heated.

7. The calcination system of claim 6, wherein the first calcination chamber is heated using an electric gas plasma generator.

8. The calcination system of claim 1, wherein the volume of the first calcination chamber is substantially smaller than the volume of the second calcination chamber.

9. The calcination system of claim 1, further comprising:
an input for receiving input material;
an input material heater, coupled to the input and configured to conduct the input material; and
an injection arrangement configured to receive the input material from the input material heater and inject it into the heated first calcination chamber.

10. The calcination system of claim 1, further comprising:
a particle separator coupled to the injection arrangement and configured to separate smaller particles of solid compound from the remainder of the input material, and to convey the smaller particles in a gas flow to the injection arrangement for injection into the heated first calcination chamber.

11. The calcination system of claim 1, further comprising a filter arrangement configured to receive gas from at least one of the separators and filter the gas to a higher degree of purity.

12. The calcination system of claim 1, further comprising a control unit communicatively coupled to sensors and control actuators, and configured to receive sensor signals, generate control signals and communicate control signals through a control port connected to one or more signal lines coupled to the sensors and control actuators.

13. The calcination system of claim 12, wherein the control unit is configured to control one or more of:
driving gas supply into an input material heater;
injecting gas supply into an injection arrangement;
gas heating in the particle separator;
gas pressure in the first calcination chamber; and/or
temperature in the first calcination chamber.

14. The calcination system, comprising:
an electrically heated first calcination chamber, configured to convert input material into first calcination process products comprising a solid compound and a gas in the form of carbon dioxide;
a first separator configured to receive said first calcination process products from said electrically heated first calcination chamber and separate said solid compound from the carbon dioxide;
a thermally insulated second calcination chamber configured to receive said solid compound, and convert it into second calcination process products comprising an oxide; and
a second separator configured to receive said second calcination process products from the thermally insulated second calcination chamber and separate said oxide.

15. The calcination system of claim 14, further comprising:
an input for receiving input material;
an input material heater coupled to said input and configured to preheat the input material; and
an injection arrangement configured to receive the input material from the input material heater and inject it into the electrically heated first calcination chamber.

16. The calcination system of claim 15, further comprising:
a particle separator coupled to the injection arrangement and configured to separate larger lumps and smaller particles of solid compound in the input material, and to convey said smaller particles in a gas flow to said injection arrangement for injection into said electrically heated calcination chamber.

17. The calcination system of claim 14, further comprising a filter arrangement configured to receive gas in the form of carbon dioxide from at least one of the separators and filter said gas to a higher degree of purity.

18. The calcination system of claim 14, further comprising a control unit communicatively coupled to sensors and control actuators, and configured to receive sensor signals, generate control signals and communicate control signals through a control port connected to one or more signal lines coupled to said sensors and control actuators.

19. The calcination system of claim 18, wherein the control unit is configured to control one or more of:
driving gas supply into a media separated heat exchanger;
injecting gas supply into an injection arrangement;
gas heating in the particle separator;
gas pressure in the first calcination chamber; or
temperature in the first calcination chamber.

20. A calcination method, comprising:
injecting input material, into a heated first calcination chamber;
converting in the heated first calcination chamber, the input material into a first calcination process product comprising gas and a solid compound;
transferring the first calcination process product to at least one thermally insulated, unheated, second calcination chamber;
converting, in the at least one thermally insulated second calcination chamber, the first calcination process product into a second calcination process product comprising gas and a solid compound;
transferring the second calcination process products to a separator; and
separating, in the separator, the gas from the solid compound.

21. The calcination method of claim 20, further comprising:
transferring the first calcination process products from the heated first calcination chamber to a pre-separator; and
separating, in the pre-separator, the gas from the solid compound.

22. The calcination method of claim 20, further comprising heating the first calcination chamber using electrical heating.

23. The calcination method of claim 22, further comprising heating the first calcination chamber using an electric gas plasma generator.

24. The calcination method of claim 20, further comprising:
receiving input material;
conducting the input material in an input material heater; and
using an injection arrangement when injecting the input material into the heated first calcination chamber.

25. The calcination method of claim 24, further comprising separating, in a particle separator coupled to the injection arrangement, smaller particles of solid compound from the remainder of the input material, and conveying the smaller particles in a gas flow to the injection arrangement for injection into the heated first calcination chamber.

26. The calcination method of claim 20, further comprising filtering, in a filter arrangement, the gas received from at least one of the separators to a higher degree of purity.

27. The calcination method of claim 20, further comprising in a control unit communicatively coupled to sensors and control actuators, receiving sensor signals, generating control signals and communicating control signals through a control port connected to one or more signal lines coupled to the sensors and control actuators.

28. The calcination method of claim 20, further comprising controlling one or more of:
driving gas supply into an input material heater;
injecting gas supply into an injection arrangement;
gas heating in the particle separator;
gas pressure in the first calcination chamber; or
temperature in the first calcination chamber.

29. The calcination method of claim 20, comprising:
injecting an input material, e.g. lime mud, into an electrically heated first calcination chamber;
converting, in said electrically heated first calcination chamber, input material, e.g. lime mud, into first calcination process products comprising a solid compound and a gas in the form of carbon dioxide;
transferring said first calcination process products to a first separator;
separating, in said first separator, said solid compound from said gas in the form of carbon dioxide;
transferring said solid compound to an, optionally thermally insulated, second calcination chamber;
converting, in said, optionally thermally insulated, second calcination chamber, said solid compound into second calcination process products comprising calcium oxide and gas in the form of carbon dioxide;
transferring said second calcination process products to a second separator; and
separating, in said second separator, said calcium oxide from said gas in the form of carbon dioxide.

30. The calcination method of claim 29, further comprising:
receiving input material in the form of lime mud;
conducting said input material via an input material heater, thereby preheating said input material; and
using an injection arrangement when injecting the preheated input material into the electrically heated first calcination chamber.

31. The calcination method of claim 30, further comprising separating, in a particle separator coupled to the injection arrangement, larger lumps from smaller particles of solid compound in the input material, and conveying said smaller particles in a gas flow to said injection arrangement for injection into said electrically heated first calcination chamber.

32. The calcination method of claim 29, further comprising filtering, in a filter arrangement gas in the form of carbon dioxide, received from at least one of the separators, to a higher degree of purity.

33. The calcination method of claim 29, further comprising in a control unit communicatively coupled to sensors and control actuators, receiving sensor signals, generating control signals and communicating control signals through a control port connected to one or more signal lines coupled to said sensors and control actuators.

34. The calcination method of claim 29, further comprising controlling one or more of:
driving gas supply into a media separated heat exchanger;
injecting gas supply into an injection arrangement;
gas heating in the particle separator;
gas pressure in the first calcination chamber; and/or
temperature in the first calcination chamber.

35. The calcination method of claim 20 being configured for calcination and causticization, comprising:
receiving input material in the form of lime mud;
extracting water vapor from said lime mud a lime mud drying chamber, thereby turning said lime mud into dried lime mud;
converting, in at least one calcination reactor, said dried lime mud into calcination process products comprising a solid compound in the form of calcium oxide and a gas in the form of carbon dioxide;
receiving said calcination process products from the at least one calcination reactor in at least one separator, and separating said calcium oxide from said carbon dioxide;
slaking said calcium oxide in a slaker, using water vapor extracted from the lime mud in the lime mud drying chamber;
transferring the slaked calcium oxide, at a temperature of at least 103 degrees Celsius, to a mixer;
mixing the slaked calcium oxide with green liquor in the mixer;
transferring the mixture to one or more causticization chambers; and
causticizating the mixture in said one or more causticization chambers.

36. The calcination method of claim 35, further comprising storing the slaked calcium oxide in at least one slaked calcium oxide storage container, before it is introduced into the mixer.

37. The calcination system of claim 1 being configured for calcination and causticization, comprising:
an input for receiving input material in the form of lime mud;
a lime mud drying chamber, configured to extract water vapor from said lime mud, thereby turning it into dried lime mud;
at least one calcination reactor, configured to convert said dried lime mud into calcination process products comprising a solid compound in the form of calcium oxide and a gas in the form of carbon dioxide;
at least one separator, configured to receive said calcination process products from the at least one calcination reactor, and separate said calcium oxide from said carbon dioxide;
a slaker, configured to slake said calcium oxide with water vapor extracted from the lime mud in the lime mud drying chamber;
a mixer, configured to mix the slaked calcium oxide with green liquor; and
one or more causticization chambers, configured to causticizate the mixture; wherein the calcination and causticization system is configured to ensure that the slaked calcium oxide has a temperature of at least 103 degrees Celsius when it is introduced into the mixer.

38. The calcination system of claim 37, further comprising at least one slaked calcium oxide storage container, configured to store the slaked calcium oxide before it is introduced into the mixer.
